(19) United States
(12) Patent Application Publication
(10) Pub. No.: US 2015/0176343 A1
(43) Pub. Date: Jun. 25, 2015

(54) Drill Bit and Chuck Isolator

(71) Applicant: CORRY RUBBER CORPORATION, Corry, PA (US)

(72) Inventors: Robert Joseph Michael, Waterford, PA (US); Ernest B. Ferro, JR., Corry, PA (US); Jeffrey A. Ferro, Corry, PA (US); David Scott Yantek, Bethel Park, PA (US); Lynn A. Alcorn, Greensburg, PA (US)

(73) Assignee: CORRY RUBBER CORPORATION, Corry, PA (US)

(21) Appl. No.: 14/370,206

(22) PCT Filed: Jan. 3, 2013
(86) PCT No.: PCT/US13/20117

§ 371 Date: Jul. 1, 2014

Related U.S. Application Data
(60) Provisional application No. 61/582,689, filed on Jan. 3, 2012.
(60) Provisional application No. 61/746,178, filed on Dec. 27, 2012.

(51) Int. Cl. E21B 17/07; F16D 3/12; E21B 7/02

(52) U.S. Cl. CPC E21B 17/07; E21B 7/028; E21B 17/076; F16D 3/12

(57) ABSTRACT

An isolator for a drill assembly that is mountable to a drill is presented. The isolator comprises an elongated outer member with an elongated inner member inserted within the outer member. An elastomer is interposed in the space between said inner member and said outer member. The isolator is connectable to a drill assembly at one end through the outer member and at the other end through the inner member. The isolator is capable of providing sound and vibration isolation when the drill assembly is mounted to a drill.

This application takes priority from U.S. Provisional Patent Applications No. 61/582,689 filed on Jan. 3, 2012, Ser. No. 61/746,178 filed on Dec. 27, 2012, Ser. No. 61/746,186 filed on Dec. 27, 2012 each of which are incorporated herein by reference.

### BACKGROUND

What is presented is a sound damping apparatus for drill assemblies. Drill assemblies can be, for example, a roof bolt drill assembly as used in underground mining operations.

Drill assemblies are typically mounted to the chuck of a drill at one end. A drill bit is mounted on the opposing end of the drill assembly. The drill bit may be extended from a drilling machine, such as a roof bolting machine or the like, by interposing a drill rod or a series of drill rods which allows for drilling deeper holes into the target matter substrate—typically a wall or, in the case of mining operations, rock and/or minerals.

One problem associated with the drilling operations is that a large amount of noise is generated. Studies have shown that, on average, drilling noise with roof bolting machines are the most significant contributor to a drilling machine operator's noise exposure. Thus, hearing loss remains one of the most common occupational illnesses for underground coal miners.

Another problem associated with the drilling operation is mechanical failure of one or more of the various components of the drill assembly that typically results from one or more factors, such as, for example, the size limitations of the drill rod components, the mechanical forces encountered in the drilling operation and the rigid connections between the various components of the drill assembly.

Thus, it would be desirable to have a drill assembly that overcomes the problems of known drill assemblies, particularly for drill assemblies used in roof bolt drilling operations.

### SUMMARY

An isolator for a drill assembly that is mountable to a drill is presented. The isolator comprises an elongated outer member that has an elongated inner member inserted within the outer member. An elastomer is interposed in the space between the inner member and the outer member. The isolator is connectable to the drill assembly at one end through the outer member and at the other end through the inner member. The isolator is capable of providing sound and vibration isolation when the drill assembly is mounted to the drill.

In various embodiments, the elastomer is variously bonded to the inner member or bonded to both the inner member and the outer member. In some embodiments, the elastomer is bonded to the inner member and compression fit into the outer member. The elastomer can be made out of polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

Some embodiments of the isolator include features that act as displacement limiters to limit the relative axial or torsional movement between the inner member and the outer member of the isolator. This serves to limit the stress on the elastomer and the bonds between the elastomer and the inner member and the outer member. In some embodiments, the inner member comprises a shoulder that acts as an axial displacement limiter that limits the axial movement of the isolator. In other embodiments, the shoulder has a collar that acts as a torsional displacement limiter that limits the torsional movement of the isolator. In yet other embodiments the inner member has a shoulder and an outer facing annular bead, and the outer member has an inner facing annular bead located between the shoulder and the outer facing annular bead to limit the axial movement of the isolator between the shoulder and the outer facing annular bead.

The shape of the components of the isolator can also be varied in different embodiments. In some embodiments, the inner member has an outer profile that is a hex shaped cross section perpendicular to the central axis of the isolator. In some embodiments that have this feature, the outer member has an inner profile that is a hex shaped cross section perpendicular to the central axis of the isolator. In other embodiments the inner member has an outer profile that is a square shaped cross section perpendicular to the central axis of the isolator. In yet other embodiments the inner member has an outer profile that is an elliptical shaped cross section perpendicular to the central axis of the isolator. Some benefits may also be seen in embodiments in which the inner member has an outer profile that is a tapered cross section in the central axis of the isolator.

These and other aspects of the present invention will be more fully understood following a review of this specification and drawings.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 shows a drill assembly with chuck and drill bit isolators installed on the chuck of a drilling machine;

FIG. 2 is an exploded view of the isolator of FIG. 1 focusing on the bit isolator showing the elements of the isolator that are coupled to the drill bit;

FIG. 3A is a view of the isolator of FIG. 1;

FIG. 3B is a cross section of the isolator of FIG. 3A;

FIG. 4 is a cross section of an isolator showing an embodiment that includes additional axial displacement limiter incorporated in the gap between the inner member and outer member of the isolator;

FIG. 5A is an embodiment of isolator that incorporates a collar on the shoulder of the inner member that acts as axial and torsional displacement limiters;

FIG. 5B is a close up of the isolator of FIG. 5A showing the isolator under maximum torsional load;

FIG. 5C is a close up of the isolator of FIG. 5A showing the isolator under maximum torsional and axial load;

FIG. 6A is another embodiment of isolator that incorporates a collar on the shoulder of the inner member that acts as axial and torsional displacement limiters;

FIG. 6B is a close up of the isolator of FIG. 6A showing the isolator under maximum torsional load;

FIG. 6C is a close up of the isolator of FIG. 6A showing the isolator under maximum torsional and axial load;

FIG. 7A is another embodiment of isolator that incorporates a collar on the shoulder of the inner member that acts as axial and torsional displacement limiters;

FIG. 7B is a close up of the isolator of FIG. 7A showing the isolator under maximum torsional load;

FIG. 7C is a close up of the isolator of FIG. 7A showing the isolator under maximum torsional and axial load;

FIG. 8A is an embodiment of isolator that incorporates a collar on the shoulder of the inner member that acts as axial displacement limiters;

FIG. 8B is a close up of the isolator of FIG. 8A showing the isolator under maximum axial load;

FIG. 9A shows an embodiment of inner member of an isolator in which the inner member has a hex shaped outer profile;

FIG. 9B shows a cross section of isolator having an inner member as shown in FIG. 9A;

FIG. 10A shows an embodiment of isolator in which both the inner member and outer member have a hex shaped outer profile and the inner member also has a tapered shape;

FIG. 10B is a cross section of the isolator of FIG. 10A showing the hex shaped outer profiles of the inner member and the outer member;

FIG. 10C is a cross section of the isolator of FIG. 10A showing the tapered shape of the inner member;

FIG. 11A is an embodiment of isolator in which both the outer profile of the inner member and the inner profile of the outer member are square shaped;

FIG. 11B is a cross section of the isolator of FIG. 11A showing the square shaped profiles of the inner member and the outer member;

FIG. 11C is a cross section of the isolator of FIG. 11A;

FIG. 12A is a cross-section of an embodiment of isolator in which the outer profile of the inner member is elliptical;

FIG. 12B is another cross section of the isolator of FIG. 12A showing the elliptical shaped outer profile of the inner member;

FIG. 13A shows a perspective view of the chuck of a drilling machine; and

FIG. 13B is a cross section of the chuck of FIG. 13A showing an isolator incorporated within the chuck.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

In rock drilling operations, one notable source of noise generation is vibration of the drill rods. There are three fundamental ways to reduce these vibrations, and the resulting noise: reduce the source of the vibration, attenuate the structural vibration using isolation or damping treatments, or attenuate the airborne noise by using barriers or absorbers. The National Institute for Occupational Safety and Health (NIOSH) Office of Mine Safety and Health Research (OMSHR) has conducted various studies to quantify the vibration levels of the components associated with drilling roof bolt bore holes. The results show a major source of noise is located just above the chuck and a second major source of noise centered on the drill rod, below the interface of the drill rod and the media which the drill is cutting into. These two areas were also shown to have high vibration levels. Therefore vibration isolation and damping are considered to be appropriate noise control methods.

Most of the noise emitted during drilling of rock media is due to noise radiated by the drill rods and chuck in response to forces at the drill bit-media interface. During drilling, the vibratory forces, generated at the drill bit-media interface, are transmitted to the drill rods and the chuck causing them to vibrate. Assuming linear viscous damping, the response of the structure is governed by:

[M]X″+[C]X′+[K]X=[F] (1)

where [M], [C], and [K] are the mass matrix, damping matrix, and stiffness of the structure; [F] is the vector of applied forces; and X″, X′, and X are the acceleration, velocity, and displacement response of the structure. Using the Laplace transform, substituting s=jω, and rearranging Equation (1) to solve for X yields:

[X]=[K+jωC−ω²M]⁻¹[F] (2)

where ω is the forcing frequency in units of rad/s and j denotes the √−1.

Assuming the damping is small enough to be ignored compared to the stiffness and the mass times the frequency squared, Equation (2) is reduced to:

[X]=[K−ω²M]⁻¹[F] (3)

For a fixed stiffness, Equation (3) shows that the response decreases with frequency squared once the frequency is well beyond the value where the ω²M term exceeds the stiffness, K. Furthermore, if the stiffness of the system is reduced, the frequency at which the ω²M term exceeds the stiffness will decrease. Thus, isolation is achieved by decreasing the stiffness of the system. The stiffness of the system can be decreased by adding compliance via an isolation device. This would decrease the response of the system to high frequency input forces.

For a vibrating object, the sound power radiated is given by the following:

W=ρcS [symbol] v² [symbol] σ_{rad} (4)

where W is the sound power radiated, <v²> is the mean-squared vibration velocity, S is the vibrating area, ρ is the air density (km/m³), c is the speed of sound (m/s), and σ_{rad} is the radiation efficiency. Equation (4) shows that the sound power radiated by a vibrating structure will be reduced if the surface-averaged mean-squared vibration velocity is reduced. Because the vibration velocity is directly related to the displacement response of the system, reducing the displacement response of the system will reduce the radiated noise. This can be accomplished with a properly designed vibration isolator.

As will be appreciated from the description and drawings set forth herein, such a vibration isolator provides for reduced noise during a drilling operation, as well as improved mechanical durability and flexibility of the drill assembly during the drilling operation.

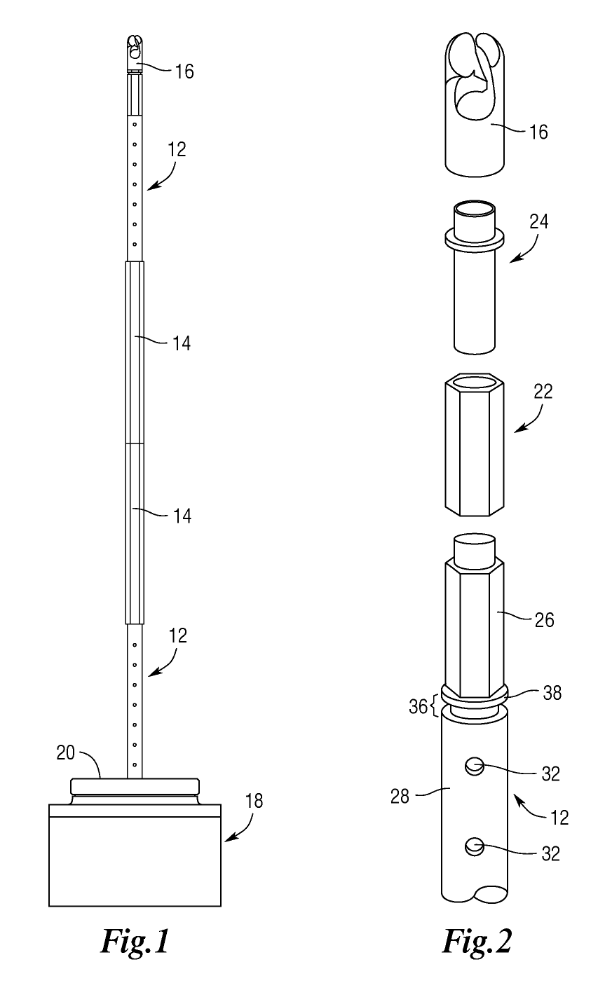

FIG. 1 illustrates a drill assembly 10 (e.g. a roof drill bit assembly) that incorporates embodiments of an isolator 12 that incorporates some of the vibration and sound isolation principles outlined above and that operates as both a chuck isolator and a bit isolator. It will be appreciated that the invention is not limited to a roof bolt drill assembly and that drill assemblies for other applications would equally benefit, but such an assembly is provided for purposes of illustration. In the embodiment shown in FIG. 1, the chuck isolator and the bit isolator are identical, eliminating the need to have two complex metal components. Because a single design can be used, the production volume is expected to increase, which would reduce the cost of the isolators. It will be appreciated that any of the variations of isolators shown herein, and their equivalents, could be used interchangeably as bit isolators or chuck isolators as appropriate.

The drill assembly 10 includes one or more drill rods 14 that are removably connected between the isolators 12. The isolator 12 that is functioning as a bit isolator is removably connected a drill bit 16 that is removably connected to the other end of the bit isolator. The drill assembly 10 also includes a means for driving the drill assembly 10 which may be, for example, a drill or drilling machine 18. The entire drill assembly 10 is mounted to a chuck 20 on the drilling machine 18 by removably attaching the isolator 12 that is serving as a chuck isolator to the chuck 20. While the drill assembly 10 will see the most improved reduction in vibration and noise with the inclusion of two isolators 12—the chuck isolator and bit isolator, it will be understood that significant improvement to vibration and noise reduction can be achieved with the inclusion of only one chuck isolator or bit isolator.

As best shown by comparing FIGS. 1 and 2, a bit coupler 24 is used to connect the drill bit 16 to the isolator 12, making it a bit isolator. If needed, a drill rod spacer 22 is interposed between the bit coupler 24 and the isolator 12. Because the bit coupler 24 is not integral to the isolator 12, if the bit coupler 24 wears, only the bit coupler 24 needs to be replaced, not the entire isolator 12. These elements are not necessary in every embodiment, and it will be understood that the drill bit 16 could be mounted directly to the isolator 12 in some embodiments. In fact, embodiments could be manufactured in which the isolator 12 serves specifically as a bit isolator or specifically as a chuck isolator, but it is understood that such embodiments limit the manufacturing economies of scale. One of the limitations of designing these isolators 12 is that the isolator 12 cannot be wider than the drill bit 16, because an isolator 12 located directly behind the drill bit 16 should not impede the progress of the drill bit 16 through the drilled medium, otherwise the isolator 12 will limit the depth to which the drill can operate.

In some applications, the drill rods 14 may be eliminated if no extension of the drill bit 16 is required. In fact, in some applications, a single isolator 12, whether a chuck isolator or bit isolator, by itself may provide sufficient extension of the drill bit 16 such that the drill assembly 10 would then comprise the drill bit 16 mounted to the isolator 12 which is mounted to the chuck 20 of the assembly of the drilling machine 18. In these instances, the chosen isolator 12 will act as both a chuck isolator and a bit isolator as defined herein. A consideration of the bit isolator is that this isolator should not be wider than the drill bit 16, so as not to interfere with drilling operations.

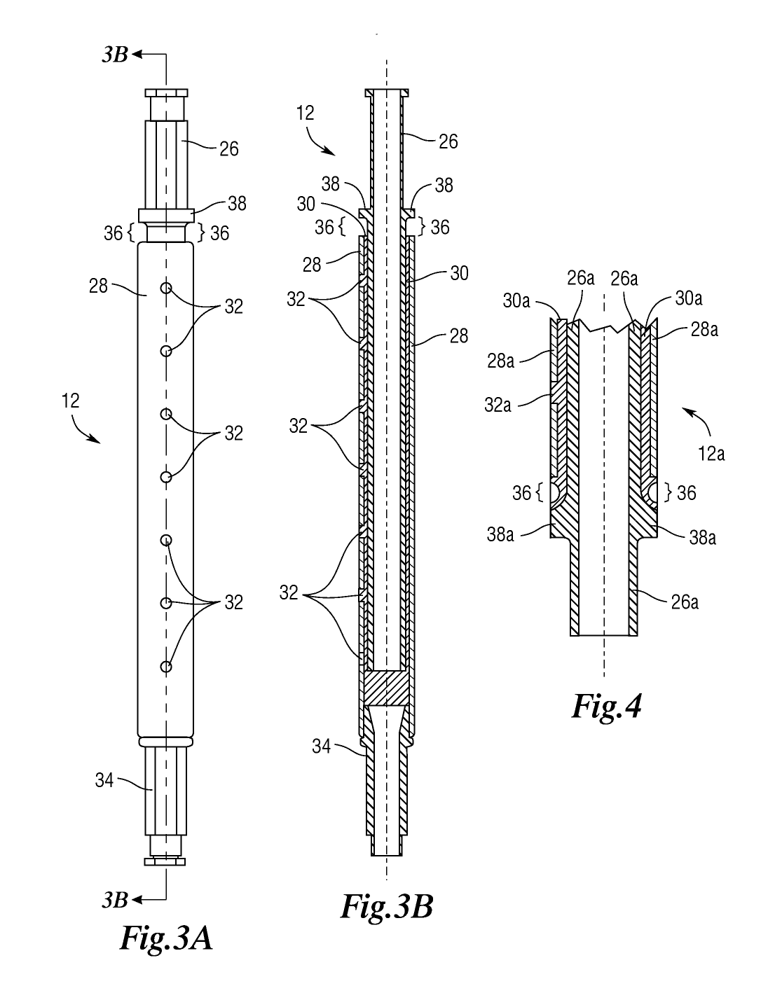

As shown in FIGS. 3A and 3B, the isolator 12 comprises: an inner member 26, an outer member 28, and an elastomer 30. The elastomer 30 provides compliance in multiple directions and provides sound and vibration isolation. The outer member 28 and the inner member 26 are typically machined out of 4130/4140 steel and heat treated to 35 HRC. However, it will be understood that other materials may be utilized if the particular applications requires it. The elastomer 30 can be any appropriate material including polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or other heavily damped elastomer such as those that may be manufactured by Corry Rubber Corporation of Corry, Pa. The dynamic modulus and loss factor (damping) of the elastomer are determined for optimal noise and vibration isolation.

In the embodiment shown in FIGS. 1 through 3B, the elastomer 30 is chemically bonded between the inner member 26 and the outer member 28 in a mold machine. As best shown by comparing FIGS. 3A and 3B, in this embodiment, the isolator is manufactured by arranging the inner member 26 and outer member 28 into a mold in their desired final locations. The mold accommodates a device to ensure the inner member 26 maintains a hollow channel. Liquid elastomer 30 is injected into the machine to fill the spaces between the inner member 26 and the outer member 28. In the embodiment shown in FIGS. 1 though 3B, the outer member 28 incorporates a series of holes 32 through which elastomer 30 can flow, providing additional surface area on the outer member 28 to which the elastomer 30 can bond, thereby increasing the strength of the bond and making the outer member 28 more secure within the isolator. The holes 32 are not required and embodiments without such holes 32 would still fulfill the requirements of the isolators described herein.

It is also possible to chemically bond the elastomer 30 to just the inner member 26 and then compress the elastomer 30 into the outer member 28. The embodiments in which the elastomer 30 is bonded to both the inner member 26 and the outer member 28 are preferred in applications that require their superior bond strength and load carrying capacity, over embodiments in which the elastomer 30 is just bonded to the inner member 26. However, elastomer bonded to an inner member 26 and subsequently pressed into an outer member 28 places the elastomer in pre-compression. Elastomer in pre-compression can have a significant improvement in fatigue life (the result of a net compression strain that must be overcome before the elastomer can be in a state of tension or shear).

An end cap 34 is joined to the outer member 28 after the elastomer 30 is bonded to the outer member 28 and the isolator 12 is ejected from the mold. The end cap is typically welded to the outer member, but it should be understood that any permanent joining means could be used. In the embodiment shown in FIG. 2, both ends of the isolator 12 have male ends, allowing the isolator 12 to be positioned along any point of the drill rods 14, or act as a replacement to a drill rod 14 if needed. Having both ends being male also allows the isolator 12 to be oriented in either direction without adversely affecting performance. It will be understood, that the type of end connector can be something besides male ends, such as female ends, male or female screw threads, or any other type of connector. In addition, each end could have a different type of connector, however doing so could limit the orientation of the isolator 12 within the drill assembly 10.

The small gap 36, best seen in FIGS. 3A and 3B, between the outer member 28 and the shoulder 38 formed on the inner member 26 acts as an axial displacement limiter protecting the elastomer 30 from overload. This serves to limit the stress on the elastomer 30 and the bonds between the elastomer 30 and the inner member 26 and the outer member 28. When the drilling machine 18 is in operation, and the drill bit 16 is pressed against the matter to be drilled, axial thrust force is applied to the drill bit 16 and transmitted through the isolator 12. In some degree the axial thrust force is resisted by the characteristics of the elastomer 30 itself, but some axial thrust compliance will be experienced which will shorten the gap 36. However, if the force is large enough, the extent of this compliance will be limited by the gap 36 because the outer member 28 will bottom out against the shoulder 38 on the inner member 26 and actively eliminate the gap 36. When the gap 36 is eliminated, metal-on-metal contact between the inner member 26 and the outer member 28 will support the elastomer 30 and the elastomer 30 will experience no further axial thrust compliance. When the axial thrust force is relieved, the elastomer 30 will return the inner member 26 and the outer member 28 to their previous positions, restoring the gap 36.

The isolator 12 reduces the amount of vibration and noise generated during drilling operations. The isolator 12 also reduces the potential for mechanical failure of the drill assembly 10 during operation. Specifically, the elastomer 30 in the isolator 12 increases the flexibility of the drill assembly 10. For example, drill assemblies 10 without such isolators 12 have a stiff or rigid mechanical connection between the chuck 20 of the drill machine 18 and the drill rods 16. During operation, these components experience large mechanical stresses and/or forces due to the nature of the drilling process. Thus, it will be appreciated that the isolator 12 advantageously reduces the mechanical stresses and/or forces that the drill assembly 10 components are subjected to as a result of the elastomer 30, providing for improved overall flexibility between the various components of the drill assembly 10.

The elastomer 30 also provides torsional compliance in the direction of rotation of the drill assembly 10. In addition, the nature of the elastomer 30 provides radial and cocking compliance to reduce the overall stiffness of the drill assembly 10 to better react to bending loads imposed during operation. The stiffness is inherent in the elastomer 30, meaning that it would take a large amount of force for the elastomer 30 to be displaced, if at all. Therefore, it would take extreme circumstances to actually cause substantial movement, increasing the overall life of the drill assembly 10.

If additional axial stiffness is required by a particular application, FIG. 4 shows an embodiment of isolator 12a in which the elastomer 30a is extended to fill the gap 36a between the inner member 26a and the outer member 28a. In this case, a small contour is shaped into the elastomer 30a within the gap 36a to provide elastomer to elastomer snubbing upon axial overload.

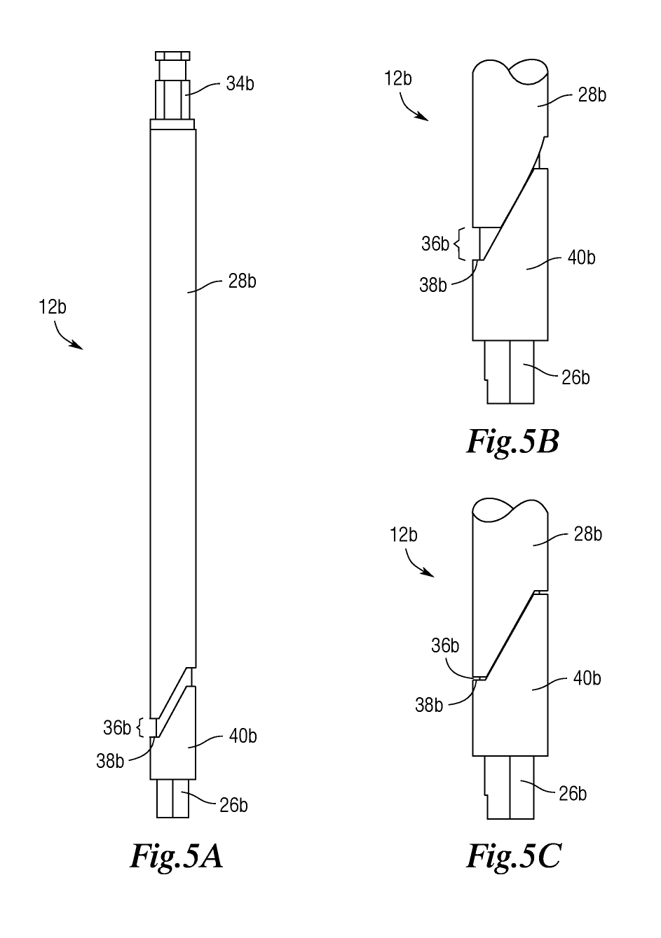

Variations of isolators providing torsional displacement limiter are also possible. For example, in the embodiment of isolator 12b shown in FIG. 5A, a collar 40b is joined onto the shoulder 38b on the inner member 26b. Typically the collar 40b is welded or formed onto the shoulder, but it will be understood that other permanent joining methodologies may work. The outer member 28b is cut to match the profile of the collar 40b. As shown in FIG. 5B, when the drill is in operation, the isolator 12b will experience twisting torsional force. The compliance inherent in the elastomer 30b will allow the inner member 26b and the outer member 28b to rotate relative to each other. However, some stiffness is inherent in the elastomer 30b, such that it would take some amount of force for the elastomer 30b to be displaced, if at all. Therefore, substantial relative movement of the inner member 26b to the outer member 28b would occur only in extreme circumstances. Nevertheless, rotation will be limited by the distance between the collar 40b and the side wall of the outer member 28b. This helps ensure that the elastomer 30b is not under enough strain to actually damage the isolator 12b. Similarly, as shown in FIG. 5C, the shoulder 38b, still acts as a displacement limiter in the axial direction as with the embodiments described above to limit the stress on the elastomer 30b and the bonds between the elastomer 30b and the inner member 26b and the outer member 28b.

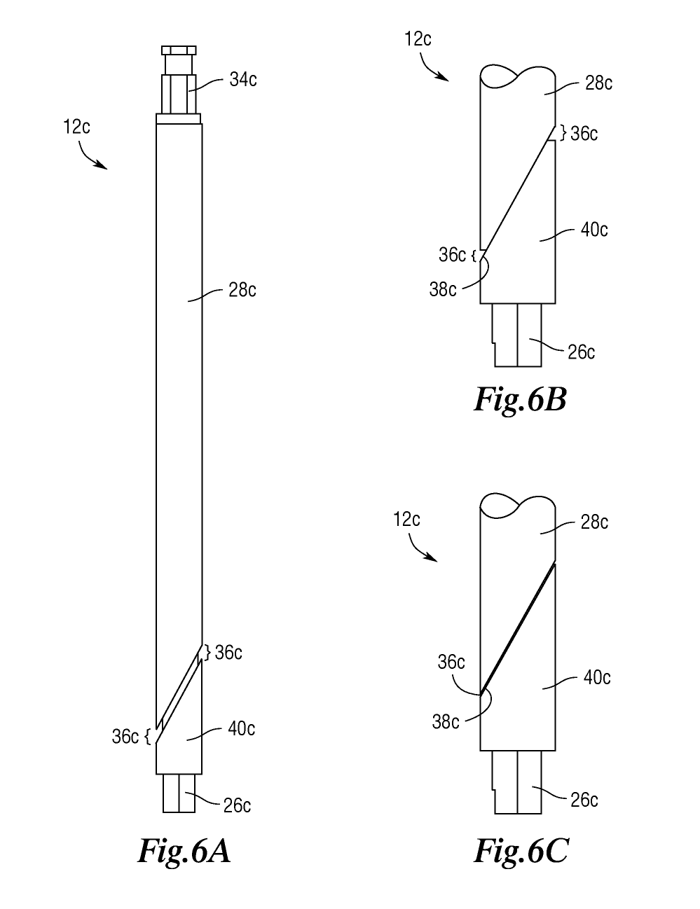

Another variation of isolator 12c incorporating torsional and axial displacement limiters is shown in FIGS. 6A-6C. In this embodiment of isolator 12c, the collar 40c is joined onto the shoulder 38c on the inner member 26c at a straight 45-degree angle, relative to the central axis of the isolator 12c. Typically the collar 40c is welded or formed onto the shoulder, but it will be understood that other permanent joining means are acceptable. The outer member 28c is cut to match the profile of the collar 40c. As shown in FIG. 6B, when the drill is in operation, the isolator 12c will experience twisting torsional force. The compliance inherent in the elastomer 30c will allow the inner member 26c and the outer member 28c to rotate relative to each other. However, stiffness is inherent in the elastomer 30c, meaning that it would take a large amount of force for the elastomer 30c to be displaced, if at all. Therefore substantial relative movement of the inner member 26c to the outer member 28c would occur only in extreme circumstances. Nevertheless, this rotation will be limited by the distance between the collar 40c and the side wall of the outer member 28c. This helps ensure that the elastomer 30c is not under so much strain as to damage the isolator 12c. Similarly, as shown in FIG. 6C, the shoulder 38c, still acts as a displacement limiter in the axial direction as with the embodiments described earlier. It will be understood that the collar 40c is not limited to the 45-degree angle shown and that other angles would serve the same purpose shown.

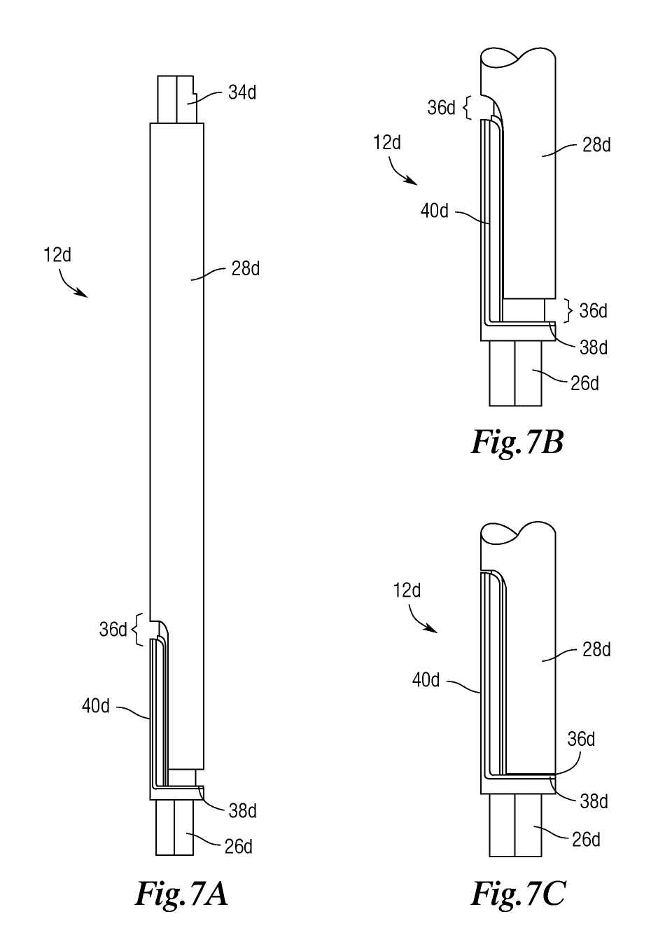

FIGS. 7A-7C show yet another variation of isolator 12d that incorporates torsional and axial displacement limiters. In this embodiment of isolator 12d, the collar 40d is joined to the shoulder 38d on the inner member 26c as an axial extension that protrudes into the area of the outer member 28d much more than other embodiments. Typically the collar 40d is welded or formed onto the shoulder, but it will be understood that other permanent joining means are acceptable. The outer member 28d is cut to match the profile of the collar 40d. As shown in FIG. 7B, when the drill is in operation, the isolator 12d will experience twisting torsional force. The compliance inherent in the elastomer 30d will allow the inner member 26d and the outer member 28d to rotate relative to each other. However, stiffness is inherent in the elastomer 30d, meaning that it would take a large amount of force for the elastomer 30d to be displaced, if at all. Therefore, substantial relative movement of the inner member 26d to the outer member 28d would occur only in extreme circumstances. Nevertheless, the rotation will be limited by the distance between the collar 40d and the side wall of the outer member 28d, helping to ensure that the elastomer 30d is not under so much strain as to damage the isolator 12d. Similarly, as shown in FIG. 7C, the shoulder 38d, still acts as a displacement limiter in the axial direction as with the embodiments described earlier.

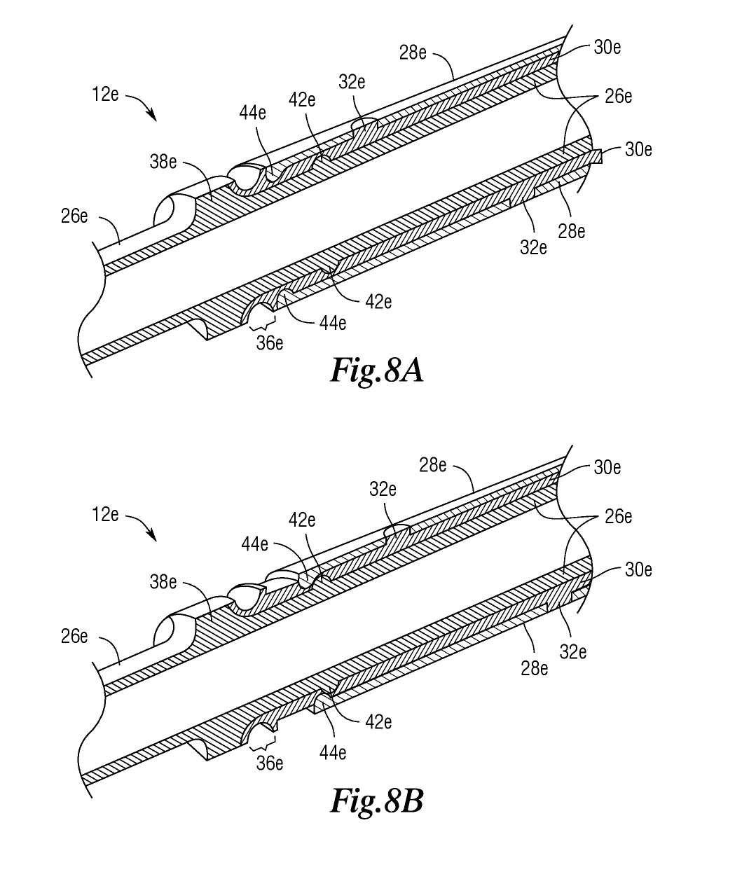

As shown in FIGS. 8A and 8B, it is also possible to provide axial displacement limits in isolators 12e in both directions. In this embodiment of isolator 12e, the inner member 26e has an outer-facing annular bead 42e is joined on its exterior, while the outer member 28e has an opposing inner-facing annular bead 44e located between the shoulder 38e and the outer-facing annular bead 42e in the assembled isolator 12e. Typically the outer-facing annular bead 44e is welded or formed on the exterior, but it will be understood that other permanent joining means are acceptable. When the isolator 12e experiences axial deflection, the displacement between the inner member 26b and the outer member 28e is limited by the displacement of the inner-facing annular bead 44e between the clearance between the shoulder 38e and the outer-facing annular bead 42e.

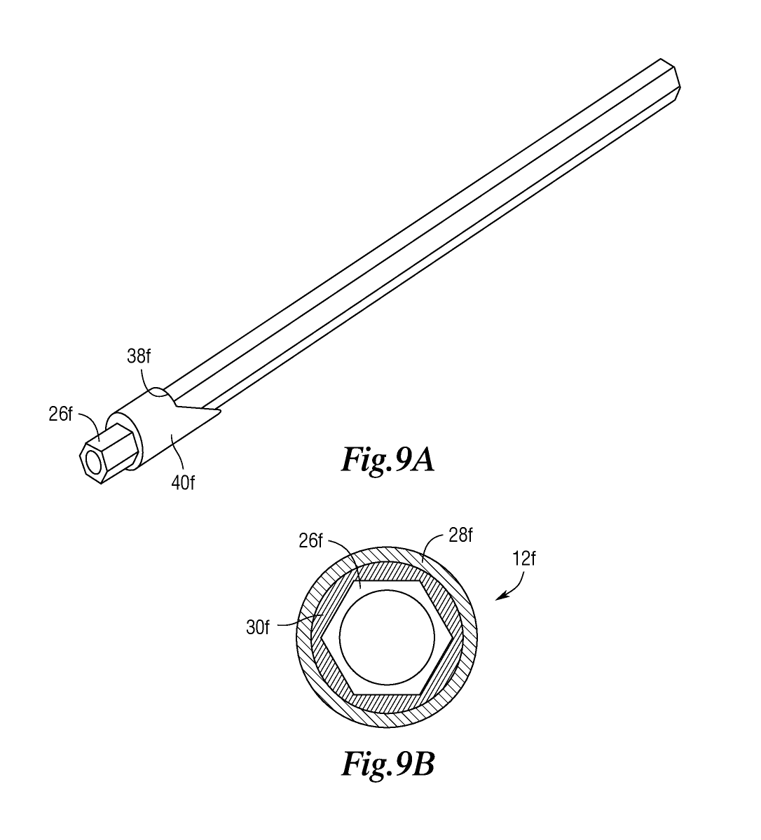

Other embodiments of isolators comprise variations of other elements to provide variations in torsional and axial load capacity. For example, the embodiment depicted in FIGS. 9A and 9B shows the inner member 26f having an outer profile that is hex-shaped. In this instance if the elastomer 30f is bonded only to the inner member 26f and the outer member 28f is compression fit into the inner member 26f (as discussed earlier), the elastomer 30f experiences both compression stress as well as shear stress during operation. Upon axial loading, the elastomer is placed in a combined state of compression and shear, which improves fatigue life and increases stiffness and load capacity. FIG. 9B shows an example of an isolator 12f with a inner member 26f having this feature.

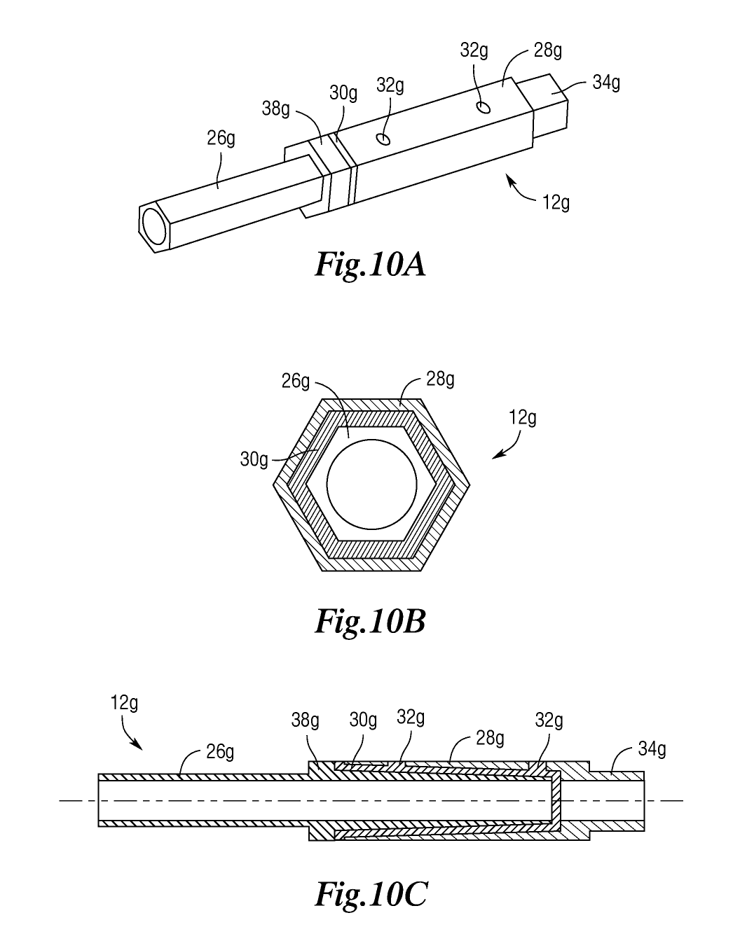

Another variation of isolator 12g is depicted in FIGS. 10A-10C. In this embodiment, the inner member 26g has an outer profile, having a hex shaped cross-section, that is perpendicular to the central axis and the outer member 28g has a matching cross-section. Moreover, the inner member 26g is tapered along the central axis as shown in FIG. 10C. This embodiment has increased load capacity in both torsion and axial directions, since the elastomer is placed in a combined state of compression and shear. The inner member 26g can be made smaller and still carry the required loads of larger embodiments that lack these features.

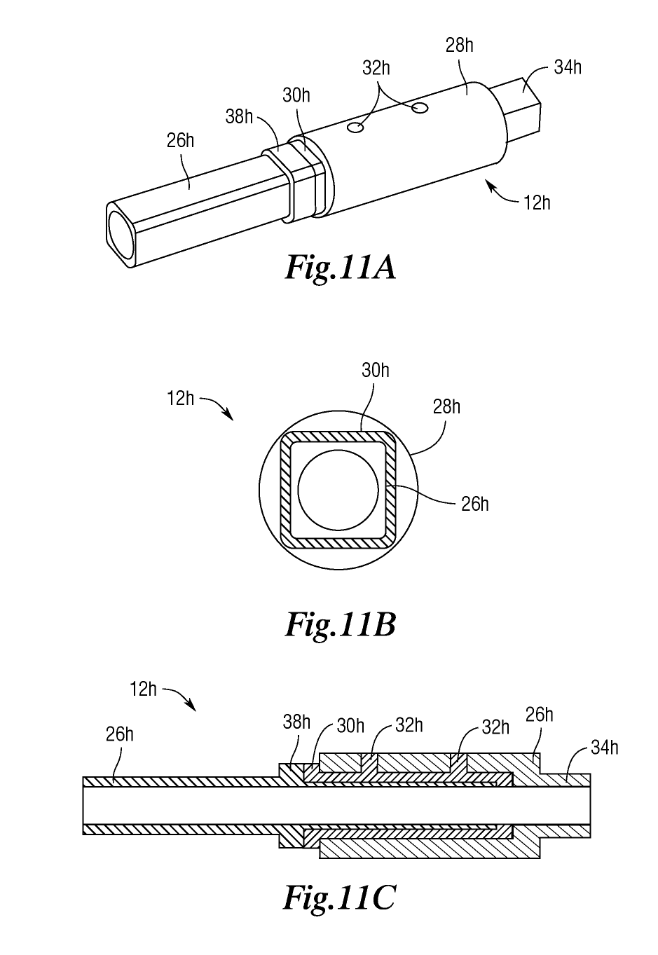

FIGS. 11A-11C depict another embodiment of isolator 12h in which the inner member 26h has an outer profile, having a square shaped cross-section, that is perpendicular to the central axis. Moreover, the outer member 28h has a matching inner profile with a circular outer profile. This embodiment of isolator 12h has increased torsional stiffness and therefore is suited for applications that require higher torque capacity.

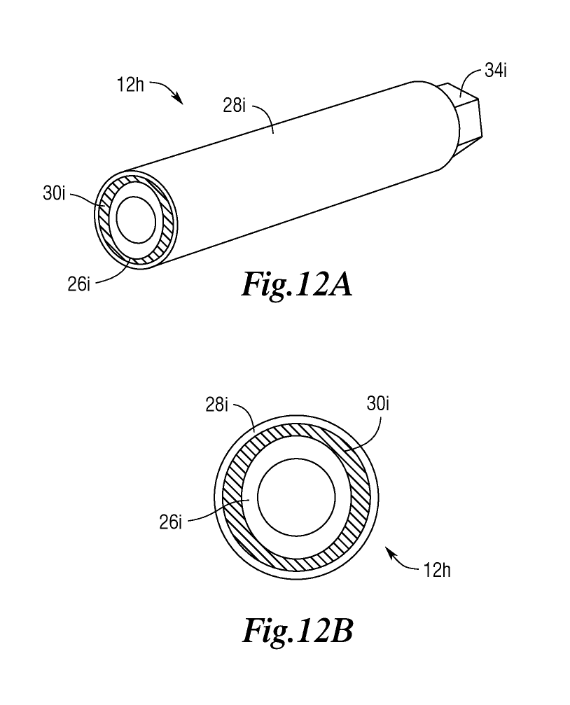

In the embodiment of isolator 12i depicted in FIGS. 12A and 12B, the inner member 261 has an inner profile, having a circular cross-section, that is perpendicular to the central axis, but an outer profile having an elliptical cross-section. The outer member 281 has both an inner and outer profile having a circular cross-section. In this embodiment, when the isolator 12i is in operation, the torque experienced by the isolator 121 places the elastomer 301 in compression which increases the overall torque capacity of the isolator 121.

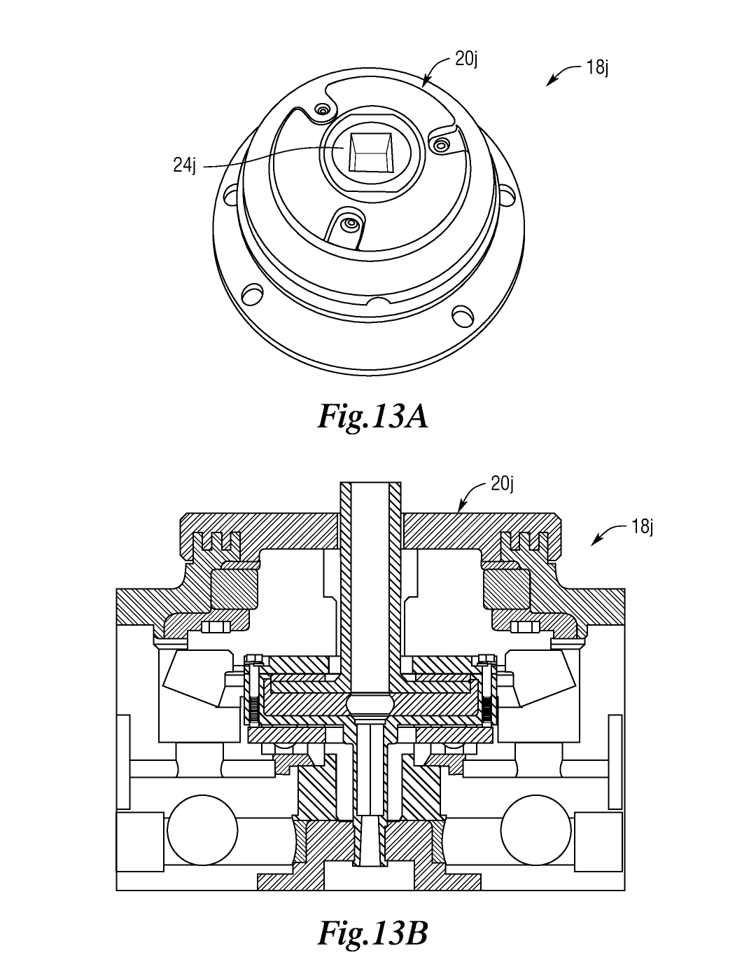

While all of the isolator embodiments discussed so far have been described as chuck isolators that are additions mounting onto the chuck of a drilling machine, it will be appreciated that any of the chuck isolator embodiments described above can be incorporated directly into the chuck of the drilling machine. FIGS. 13A and 13B show one embodiment of drilling machine 18j that incorporates a variation of the isolator 12j, shown in FIG. 3A, directly into the chuck 20j of a drilling machine 18j. Any of the other embodiments of chuck isolator shown and described herein, and their variations, can be similarly incorporated into drilling machines.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. An isolator for a drill assembly mountable to a drill, said isolator comprising:
an elongated outer member,
an elongated inner member located within said outer member;
an elastomer interposed in the space between said inner member and said outer member;
said isolator connectable to the drill assembly at one end through said outer member and at the other end through said inner member,
said isolator capable of providing sound and vibration isolation when the drill assembly is mounted to the drill.

2. The isolator of claim 1 further comprising said elastomer is bonded to said inner member.

3. The isolator of claim 1 further comprising said elastomer is bonded to both said inner member and said outer member.

4. The isolator of claim 1 further comprising said elastomer is bonded to said inner member and compression fit into said outer member.

5. The isolator of claim 1 further comprising an end cap welded to said outer member for connecting said outer member to the drill assembly.

6. The isolator of claim 1 further comprising said elastomer is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

7. The isolator of claim 1 further comprising said inner member comprises a shoulder that acts as an axial displacement limiter to limit the axial movement of said isolator.

8. The isolator of claim 1 further comprising
said inner member comprises a shoulder that acts as an axial displacement limiter to limit the axial movement of said isolator; and
said shoulder comprises a collar that acts as a torsional displacement limiter to limit the torsional movement of said isolator.

9. The isolator of claim 1 further comprising said inner member comprises a collar that acts as a torsional displacement limiter to limit the torsional movement of said isolator.

10. The isolator of claim 1 further comprising:
said inner member comprising a shoulder and an outer facing annular bead; and
said outer member comprises an inner facing annular bead located between said shoulder and said outer facing annular bead, said inner facing annular bead limits the axial movement of said isolator between said shoulder and said outer facing annular bead.

11. The isolator of claim 1 further comprising said inner member having an outer profile that has a hex shaped cross section perpendicular to the central axis of said isolator.

12. The isolator of claim 1 further comprising:
said inner member having an outer profile that has a hex shaped cross section perpendicular to the central axis of said isolator, and
said outer member having an inner profile that has a hex shaped cross section perpendicular to the central axis of said isolator.

13. The isolator of claim 1 further comprising said inner member having an outer profile that has a square shaped cross section perpendicular to the central axis of said isolator.

14. The isolator of claim 1 further comprising said inner member having an outer profile that has an elliptical shaped cross section perpendicular to the central axis of said isolator.

15. The isolator of claim 1 further comprising said inner member having an outer profile that has a tapered cross section in the central axis of said isolator.

16. The isolator of claim 1 further comprising both said inner member and said outer member are steel.

17. A bit isolator for the drill bit of a drill comprising:
an elongated outer member,
an elongated inner member located within said outer member;
an elastomer interposed in the space between said inner member and said outer member;
said bit isolator connectable to the drill bit and capable of providing sound and vibration isolation when said bit isolator is connected to the drill.

18. The bit isolator of claim 17 further comprising a drill rod spacer interposed between said bit isolator and the drill bit.

19. The bit isolator of claim 17 further comprising a bit coupler used to connect said bit isolator to the drill bit.

20. The bit isolator of claim 17 further comprising said elastomer is bonded to said inner member.

21. The bit isolator of claim 17 further comprising said elastomer is bonded to both said inner member and said outer member.

22. The bit isolator of claim 17 further comprising said elastomer is bonded to said inner member and compression fit into said outer member.

23. The bit isolator of claim 17 further comprising an end cap joined to said outer member for connecting said outer member to the drill.

24. The bit isolator of claim 17 further comprising said elastomer is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

25. The bit isolator of claim 17 further comprising said inner member comprising a shoulder that acts as an axial displacement limiter to limit the axial movement of said bit isolator.

26. The bit isolator of claim 17 further comprising:
said inner member comprises a shoulder that acts as an axial displacement limiter to limit the axial movement of said bit isolator, and
said shoulder comprises a collar that acts as a torsional displacement limiter to limit the torsional movement of said bit isolator.

27. The bit isolator of claim 17 further comprising said inner member comprising a collar that acts as a torsional displacement limiter to limit the torsional movement of said bit isolator.

28. The bit isolator of claim 17 further comprising:
said inner member comprising a shoulder and an outer facing annular bead; and
said outer member having an inner facing annular bead located between said shoulder and said outer facing annular bead, said inner facing annular bead limits the axial movement of said bit isolator between said shoulder and said outer facing annular bead.

29. The bit isolator of claim 17 further comprising said inner member has an outer profile having a hex shaped cross section perpendicular to the central axis of said bit isolator.

30. The bit isolator of claim 17 further comprising:
said inner member has an outer profile having a hex shaped cross section perpendicular to the central axis of said bit isolator; and
said outer member has an inner profile having a hex shaped cross section perpendicular to the central axis of said bit isolator.

31. The bit isolator of claim 17 further comprising said inner member has an outer profile having a square shaped cross section perpendicular to the central axis of said bit isolator.

32. The bit isolator of claim 17 further comprising said inner member has an outer profile having an elliptical shaped cross section perpendicular to the central axis of said bit isolator.

33. The bit isolator of claim 17 further comprising said inner member has an outer profile having a tapered cross section in the central axis of said bit isolator.

34. The bit isolator of claim 17 further comprising both said inner member and said outer member are steel.

35. A chuck isolator for the chuck of a drill comprising:
an elongated outer member;
an elongated inner member located within said outer member,
an elastomer interposed in the space between said inner member and said outer member,
said chuck isolator connectable to the chuck of the drill and capable of providing sound and vibration isolation when said chuck isolator is connected to the drill.

36. The chuck isolator of claim 35 further comprising said elastomer is bonded to said inner member.

37. The chuck isolator of claim 35 further comprising said elastomer is bonded to both said inner member and said outer member.

38. The chuck isolator of claim 35 further comprising said elastomer is bonded to said inner member and compression fit into said outer member.

39. The chuck isolator of claim 35 further comprising an end cap joined to said outer member for connecting said outer member to the drill.

40. The chuck isolator of claim 35 further comprising said elastomer is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

41. The chuck isolator of claim 35 further comprising said inner member comprising a shoulder that acts as an axial displacement limiter to limit the axial movement of said chuck isolator.

42. The chuck isolator of claim 35 further comprising:
said inner member comprises a shoulder that acts as an axial displacement limiter to limit the axial movement of said chuck isolator, and
said shoulder comprises a collar that acts as a torsional displacement limiter to limit the torsional movement of said chuck isolator.

43. The chuck isolator of claim 35 further comprising said inner member comprises a collar that acts as a torsional displacement limiter to limit the torsional movement of said chuck isolator.

44. The chuck isolator of claim 35 further comprising:
said inner member comprising a shoulder and an outer facing annular bead; and
said outer member having an inner facing annular bead located between said shoulder and said outer facing annular bead to limit the axial movement of said chuck isolator between said shoulder and said outer facing annular bead.

45. The chuck isolator of claim 35 further comprising said inner member has an outer profile having a hex shaped cross section perpendicular to the central axis of said chuck isolator.

46. The chuck isolator of claim 35 further comprising
said inner member has an outer profile having a hex shaped cross section perpendicular to the central axis of said chuck isolator, and
said outer member has an inner profile having a hex shaped cross section perpendicular to the central axis of said chuck isolator.

47. The chuck isolator of claim 35 further comprising said inner member has an outer profile having a square shaped cross section perpendicular to the central axis of said chuck isolator.

48. The chuck isolator of claim 35 further comprising said inner member has an outer profile having an elliptical shaped cross section perpendicular to the central axis of said chuck isolator.

49. The chuck isolator of claim 35 further comprising said inner member has an outer profile having a tapered cross section in the central axis of said chuck isolator.

50. The chuck isolator of claim 35 further comprising both said inner member and said outer member are steel.

51. A drill assembly for a drill, wherein the drill comprises a chuck for mounting to a drill assembly, the drill assembly comprising:
a drill bit; and
a first isolator comprising:
an elongated outer member;
an elongated inner member located within said outer member, and
an elastomer interposed in the space between said inner member and said outer member,
said first isolator capable of providing sound and vibration isolation when said drill assembly is mounted to the chuck.

52. The drill assembly of claim 51 further comprising a drill rod spacer interposed between both said first isolator and said drill bit.

53. The drill assembly of claim 51 further comprising said drill bit mounted to said first isolator.

54. The drill assembly of claim 51 further comprising:
said drill bit mounted to said first isolator, and
said first isolator is mountable to the chuck.

55. The drill assembly of claim 51 further comprising:
a drill rod mountable to the chuck;
said first isolator mounted to said drill rod; and
said drill bit mounted to said isolator.

56. The drill assembly of claim 51 further comprising:
a drill rod, said drill rod interposed between both said drill bit and said isolator, and
said first isolator is mountable to the chuck.

57. The drill assembly of claim 51 further comprising:
said first isolator is mountable to the chuck; and
a second isolator mounted to said drill bit.

58. The drill assembly of claim 51 further comprising:
said first isolator is mountable to the chuck;
a second isolator mounted to said drill bit; and
a drill rod interposed between both said first isolator and said second isolator.

60. The drill assembly of claim 51 further comprising a bit coupler to connect said first isolator to said drill bit.

61. The drill assembly of claim 51 further comprising said elastomer is bonded to said inner member.

62. The drill assembly of claim 51 further comprising said elastomer is bonded to said inner member and said outer member.

63. The drill assembly of claim 51 further comprising said elastomer is bonded to said inner member and compression fit into said outer member.

64. The drill assembly of claim 51 further comprising said elastomer is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

65. The drill assembly of claim 51 further comprising said inner member comprises a shoulder that acts as an axial displacement limiter to limit the axial movement of said first isolator.

66. The drill assembly of claim 51 further comprising:
said inner member comprises a shoulder that acts as an axial displacement limiter to limit the axial movement of said first isolator, and
said shoulder further comprises a collar that acts as a torsional displacement limiter to limit the torsional movement of said first isolator.

67. The drill assembly of claim 51 further comprising said inner member comprising a collar that acts as a torsional displacement limiter to limit the torsional movement of said first isolator.

68. The drill assembly of claim 51 further comprising:
said inner member comprising a shoulder and an outer facing annular bead; and
said outer member having an inner facing annular bead located between said shoulder and said outer facing annular bead, said inner facing annular bead limits the axial movement of said first isolator between said shoulder and said outer facing annular bead.

69. The drill assembly of claim 51 further comprising said inner member has an outer profile having a hex shaped cross section perpendicular to the central axis of said first isolator.

70. The drill assembly of claim 51 further comprising
said inner member has an outer profile having a hex shaped cross section perpendicular to the central axis of said first isolator, and
said outer member has an inner profile having a hex shaped cross section perpendicular to the central axis of said first isolator.

71. The drill assembly of claim 51 further comprising said inner member has an outer profile having a square shaped cross section perpendicular to the central axis of said first isolator.

72. The drill assembly of claim 51 further comprising said inner member has an outer profile having an elliptical shaped cross section perpendicular to the central axis of said first isolator.

73. The drill assembly of claim 51 further comprising said inner member has an outer profile having a tapered cross section in the central axis of said first isolator.

74. The drill assembly of claim 51 further comprising both said inner member and said outer member are steel.

75. A chuck isolator for the chuck of a drill, the chuck isolator incorporated within the chuck of the drill, comprising:
an elongated outer member,
an elongated inner member located within said outer member,
an elastomer interposed in the space between said inner member and said outer member,
said chuck isolator capable of providing sound and vibration isolation when the drill is in operation.

76. The chuck isolator of claim 75 further comprising said elastomer is bonded to said inner member.

77. The chuck isolator of claim 75 further comprising said elastomer is bonded to both said inner member and said outer member.

78. The chuck isolator of claim 75 further comprising said elastomer is bonded to said inner member and compression fit into said outer member.

79. The chuck isolator of claim 75 further comprising an end cap welded to said outer member for connecting said outer member to the drill.

80. The chuck isolator of claim 75 further comprising said elastomer is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

81. The chuck isolator of claim 75 further comprising said inner member comprising a shoulder that acts as an axial displacement limiter to limit the axial movement of said chuck isolator.

82. The chuck isolator of claim 75 further comprising
said inner member comprises a shoulder that acts as an axial displacement limiter to limit the axial movement of said chuck isolator, and
said shoulder further comprises a collar that acts as a torsional displacement limiter to limit the torsional movement of the chuck isolator.

83. The chuck isolator of claim 75 further comprising said inner member comprises a collar that acts as a torsional displacement limiter to limit the torsional movement of the chuck isolator.

84. The chuck isolator of claim 75 further comprising
said inner member comprising a shoulder and an outer facing annular bead; and
said outer member having an inner facing annular bead located between said shoulder and said outer facing annular bead, said inner facing annular bead limits the axial movement of said chuck isolator between said shoulder and said outer facing annular bead.

85. The chuck isolator of claim 75 further comprising said inner member has an outer profile having a hex shaped cross section perpendicular to the central axis of said chuck isolator.

86. The chuck isolator of claim 75 further comprising:
said inner member has an outer profile having a hex shaped cross section perpendicular to the central axis of said chuck isolator; and
said outer member has an inner profile having a hex shaped cross section perpendicular to the central axis of said chuck isolator.

87. The chuck isolator of claim 75 further comprising said inner member has an outer profile having a square shaped cross section perpendicular to the central axis of said chuck isolator.

88. The chuck isolator of claim 75 further comprising said inner member has an outer profile having an elliptical shaped cross section perpendicular to the central axis of said chuck isolator.

89. The chuck isolator of claim 75 further comprising said inner member has an outer profile having a tapered cross section in the central axis of the chuck isolator.

90. The chuck isolator of claim 75 further comprising both said inner member and said outer member are steel.
